(19) United States
(12) Patent Application Publication
(10) Pub. No.: US 2017/0045034 A1
(43) Pub. Date: Feb. 16, 2017

(54) DEVICE AND SYSTEM FOR WIND POWER GENERATION

(71) Applicant: OCCASION RENEWABLE RESOURCES COMPANY LIMITED, Hong Kong (CN)

(72) Inventors: Kam Ming LAI, Hong Kong (CN); Gomain LAI, Hong Kong (CN)

(73) Assignee: OCCASION RENEWABLE RESOURCES COMPANY LIMITED, Hong Kong (CN)

(21) Appl. No.: 15/304,071

(22) PCT Filed: Aug. 10, 2015
(86) PCT No.: PCT/CN2015/086529

§ 371 Date: Oct. 14, 2016

Related U.S. Application Data
(63) Continuation-in-part of application No. PCT/CN2015/073454, filed on Mar. 2, 2015.

(30) Foreign Application Priority Data
Aug. 12, 2014 (CN) 201410393454.X
Aug. 12, 2014 (CN) 201420451849.6

(51) Int. Cl. F03D 7/06; F03D 3/04; F03D 3/02; F03D 3/06; F03D 9/00; F03D 9/25; F03D 3/00; F03D 17/00

(52) U.S. Cl. CPC F03D 7/06; F03D 3/005; F03D 3/0418; F03D 17/00; F03D 3/061; F03D 9/002; F03D 9/25; F03D 3/02

(57) ABSTRACT

A device (10) for wind power generation, comprising: a blade assembly (20) having a plurality of radially extending blades (22) surrounding a hollow space (24); a frame structure (30) inside which the blade assembly (20) is rotatably mounted; and a power generating unit (40) connected with the blade assembly (20); wherein the blade assembly (20) is rotatable by at least one air flow directed into the blade assembly (20), so that rotation of the blade assembly (20) is adapted to drive the power generating unit (40) to thereby generate electrical energy. And a system (100) comprises a plurality of the devices (10) arranged in at least one of a horizontal and a vertical arrangement relative to one another.

### TECHNICAL FIELD

The invention relates to the field of wind power generation.

### BACKGROUND ART

Wind power has become an increasingly important renewable source of energy as an alternative to the fossil fuel generated power. Different types of wind power generators or so called ‘wind turbines’ have been used in areas where land spaces and high wind resources are available. Conventional wind turbine designs include horizontal-axis wind turbines (HAWT) and vertical-axis wind turbines (VAWT), which differ from each other by having a different orientation in the axis of rotation, i.e. horizontal or vertical, respectively. One of the most common type of HAWT includes generally two or three wind blades arranged to point towards the wind direction. The blades are connected to a rotor shaft and a power generator, which are located at the top of a tower which is typically of about tens of meters in height. Examples of VAWT include the H-type Giromills and the S-type Savonius turbines, with the terms ‘H-type’ and ‘S-type’ indicating the shape and arrangement of the wind blades.

One typical problem associated with the conventional wind turbines is the limited locations suitable for building the turbine structures, which are usually massive in size. Other than the visual impact to the landscape due their large size, operation of the wind turbines often creates noises, which may adversely affect the surrounding neighbourhood. Furthermore, conventional wind turbines and particularly, the HAWT requires reliable wind source from a specific direction in order to operate in an optimum efficiency. It is therefore undesirable to be installed in locations where wind conditions are constantly changing.

### DISCLOSURE OF INVENTION

### Technical Problem

An object of the present invention is to provide a wind power generating device, in which the aforesaid shortcomings are mitigated or at least to provide a useful alternative.

Another object of the present invention is to mitigate or obviate to some degree one or more problems associated with known wind power generators in the prior art.

The above objects are met by the combination of features of the main claims; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SOLUTION TO PROBLEM

### Technical Solution

In a first main aspect, the invention provides a device for wind power generation.

The device comprises a blade assembly having a plurality of radially extending blades surrounding a hollow space; a frame structure, with the blade assembly being rotatably mounted to the frame structure; a power generating unit connected with the blade assembly; wherein the blade assembly is rotatable by at least one air flow directed into the blade assembly, so that rotation of the blade assembly is adapted to drive the power generating unit to thereby generate electrical energy.

In a second main aspect, the invention provides a system for generating wind power comprising a plurality of the devices according to the first main aspect arranged in at least one of a horizontal and a vertical arrangement relative to one another.

The summary of the invention does not necessarily disclose all the features essential for defining the invention; the invention may reside in a sub-combination of the disclosed features.

### ADVANTAGEOUS EFFECTS OF INVENTION

### Advantageous Effects

The present invention has a number of advantages over the prior art technology. First of all, the wind power generating device of the present invention can be constructed in a much smaller size compared to the conventional wind generators, and at the same time, without compromising the power generating efficiency. This is achieved by assembling, combining or connecting a multiple power generating devices of the present invention to form a power generating system, with the number of devices required and the corresponding combination or arrangement customisable depending on the desired power requirement. It is particularly important that the various combinations of the devices in the system can be tailored to suit different location requirements. For example, in contrast to the conventional wind generators which installations are very much restricted to remote or off shore areas for the space and reliable wind sources, the present invention can be flexibly applied and installed in various locations including roof tops or walls of any buildings or structures. For example, stacks of tens of these devices can be arranged at the roof top of a commercial or residential building to form a mini wind farm even in a city area. Alternatively, a few devices can also be mounted at the outer wall of a building or even hanging down a ceiling surface to capture some wind to supplement the major power supply. In addition to the versatile installation, the device of the present invention can utilise wind from all directions to generate power. This is achievable by the controlled movement of one or more blades of the blade assembly to adjust the wind receiving angle, which can be further facilitated by the movable arrangement of the guiding baffles of the guiding assembly. The movable blade assembly and guiding assembly significantly enhance the power generating efficiency when compared with the traditional, power generating devices such as the HAWT which are designed mainly for unidirectional air flow. The present invention negates the need to build the wind generator in a specific wind facing direction, which is known to be very much inflexible and also, results in unreliable power generating efficiency under a variable wind condition. The device of the present invention is provided with a frame structure with porous side walls, which minimises any potential injuries to people or wildlife by the rotating blades. As discussed, the frame structure can be configured into different sizes and shapes, and that the system comprising multiple of such devices can be arranged to give an aesthetically pleasing structure. Last but not least, the device of the present invention is of a simple structure, which is relatively cheap to manufacture and easy to assemble. The device can also be easily accessible for replacement and maintenance.

### BRIEF DESCRIPTION OF DRAWINGS

### Description of Drawings

The foregoing and further features of the present invention will be apparent from the following description of preferred embodiments which are provided by way of example only in connection with the accompanying figures, of which:

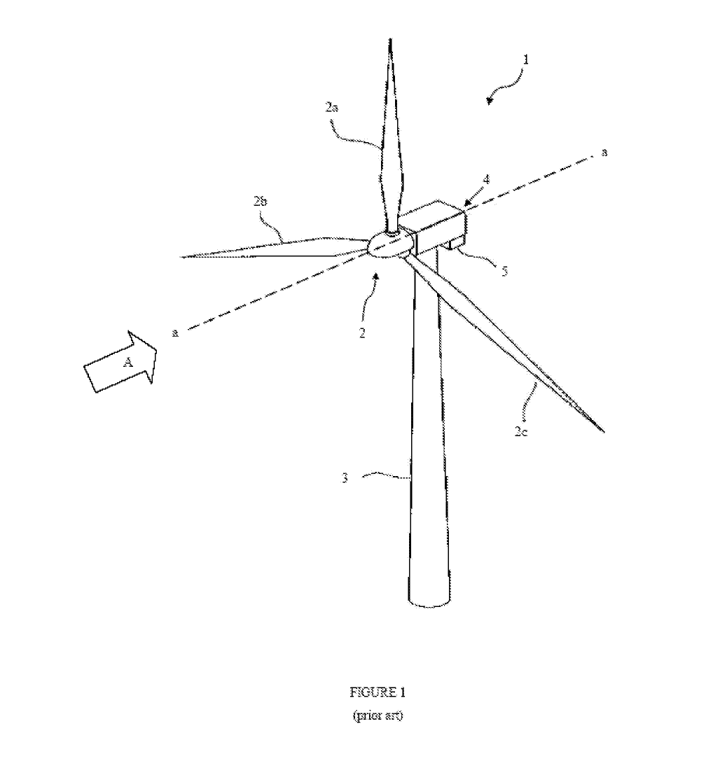

FIG. 1 is a perspective view showing a typical HAWT in the prior art;

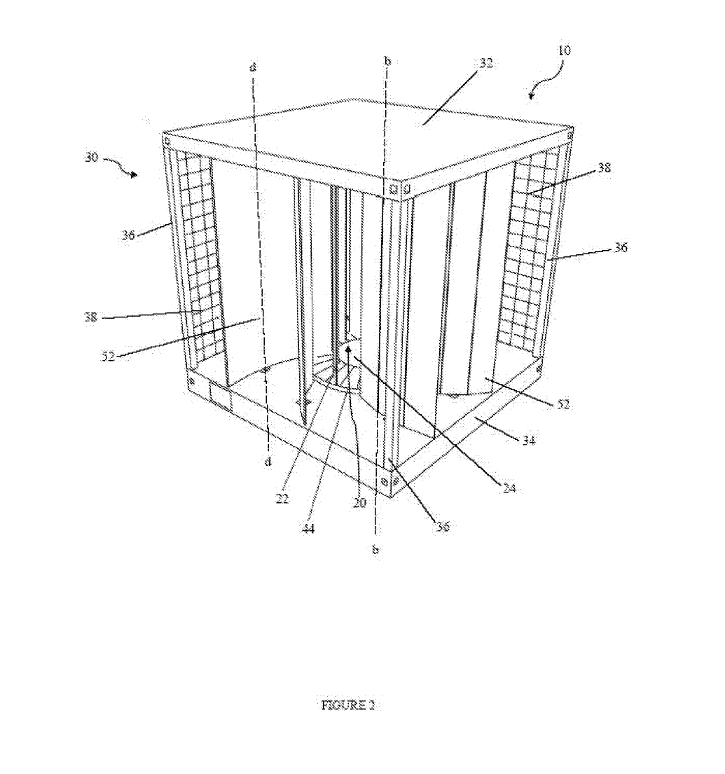

FIG. 2 is a perspective view showing an embodiment of the wind power generating device according to the present invention;

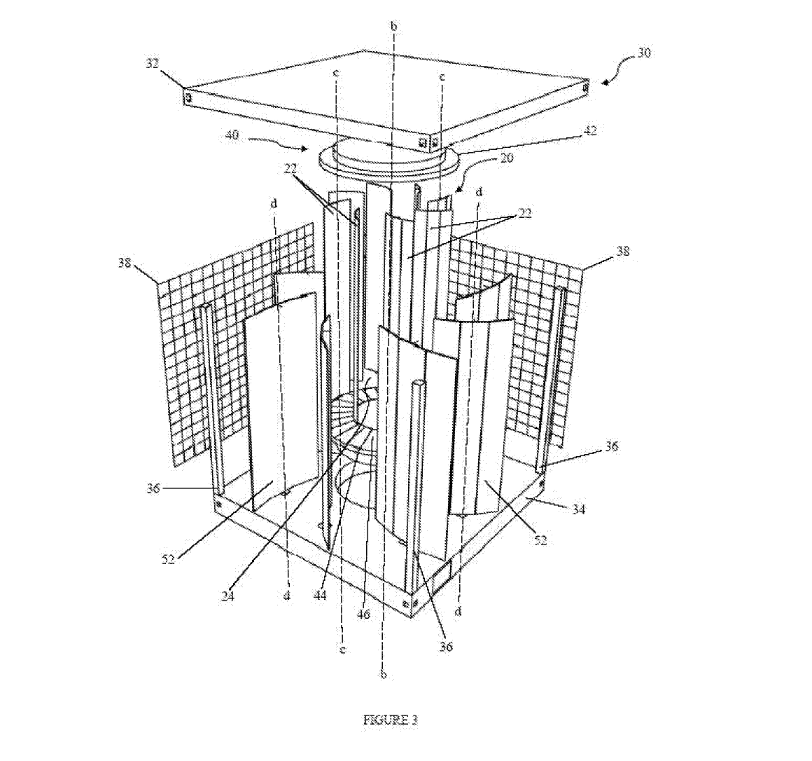

FIG. 3 is an exploded perspective view showing the embodiment of FIG. 2;

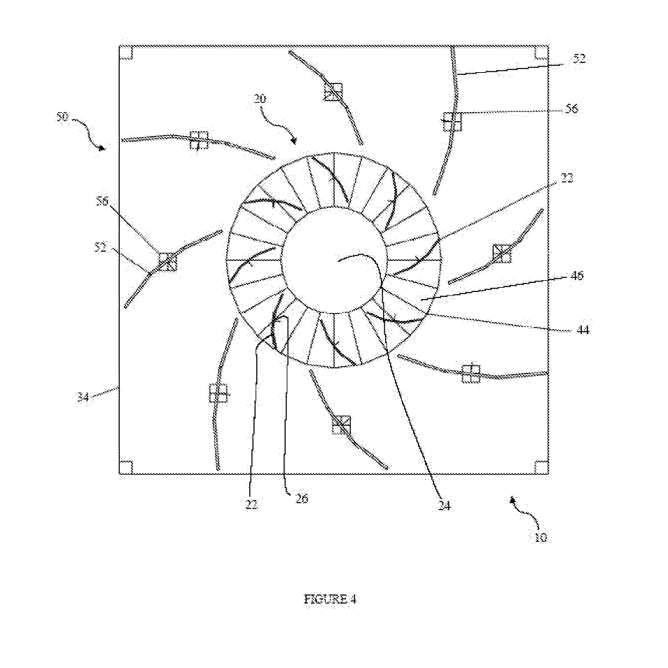

FIG. 4 is a transverse sectional view showing the embodiment of FIG. 2;

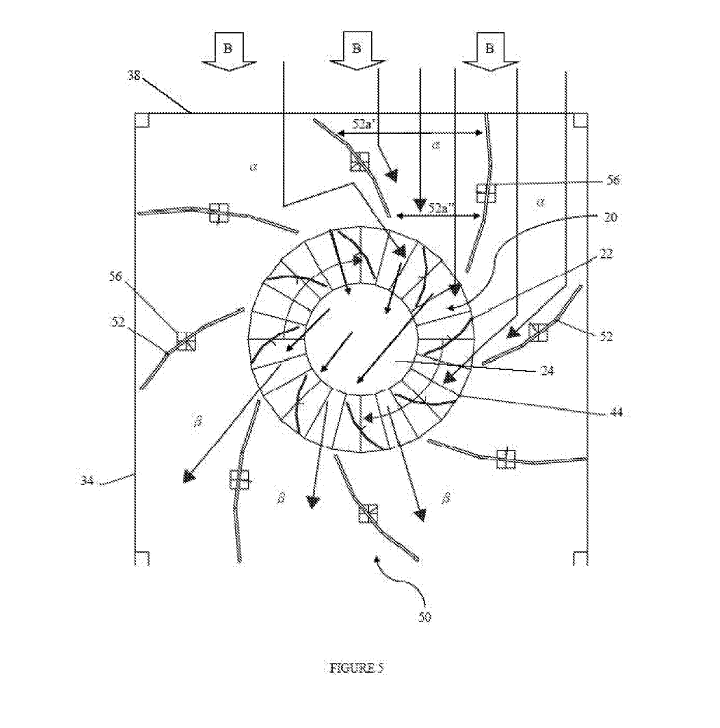

FIG. 5 is a transverse sectional view showing the embodiment of FIG. 2 with air flows indicated by arrows; and

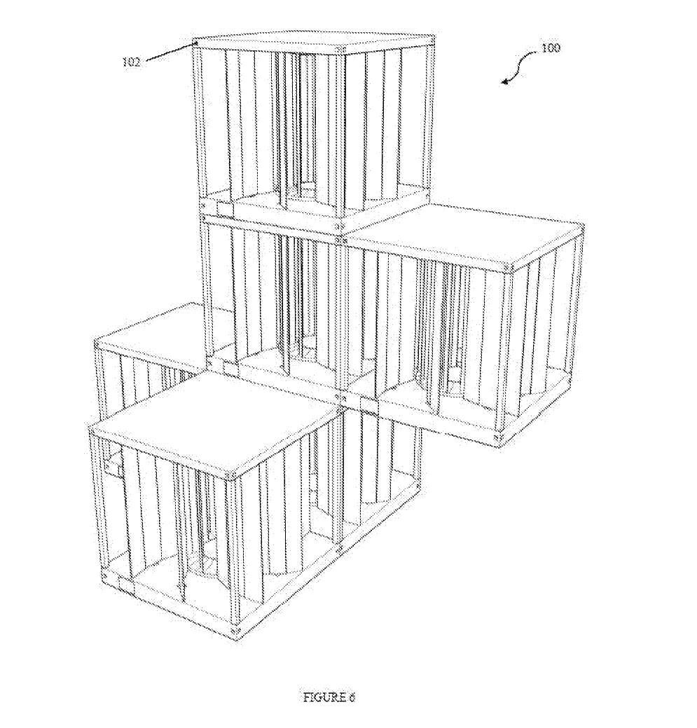

FIG. 6 is a perspective view showing a system for wind power generation according to an embodiment of the present invention.

### MODE FOR THE INVENTION

### Mode for Invention

The following is a description of preferred embodiments by way of example only and without limitation to the combination of features necessary for carrying the invention into effect.

Reference in this specification to ‘one embodiment’ or ‘an embodiment’ means that a particular feature, structure, or characteristic described in connection with the embodiment is included in at least one embodiment of the invention. The appearances of the phrase ‘in one embodiment’ in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In the claims hereof, any element expressed as a means for performing a specified function is intended to encompass any way of performing that function. The invention as defined by such claims resides in the fact that the functionalities provided by the various recited means are combined and brought together in the manner which the claims call for. It is thus regarded that any means that can provide those functionalities are equivalent to those shown herein.

A wind power generating device 1 in the prior art having one of the most common horizontal-axis wind turbines (HAWT) design is illustrated in FIG. 1. In this prior art, the axis of rotation a of the blade system 2, which comprises three blades 2a, 2b, 2c in this particular example, is substantially horizontal to the ground and is arranged to point into the direction of the wind stream A. The prior art device 1 comprises a supporting tower 3 with one end secured on the ground, and another end connected with a rotatory shaft assembly 4. The rotatory shaft assembly 4 operatively connects with the blade system 2, with the rotation of the blades 2 when driven by the wind stream A actuates an electric generator 5 to generate electric power. Due to the generally large size of the turbine and also the loud noise generated during the operation, installation of this or similar devices would normally restrict to remote, low populated areas where land spaces and high wind resources are readily available. Another drawback of this prior art device 1 is that, the blades 2 would have to arrange to face towards the direction of the wind stream in order for the device to operate at its optimum power generating efficiency. This further restricts the locations suitable for building such device since variable wind directions may not only result in unreliable power generation, but also cause potential damages to the overall blade structure.

Referring to FIGS. 2 and 3, shown is a wind power generating device 10 according to an embodiment of the present invention. The device 10 comprising: a blade assembly 20 having a plurality of radially extending blades 22 surrounding a hollow space 24; a frame structure 30 inside which the blade assembly 20 is rotatably mounted; and a power generating unit 40 connected with the blade assembly 20; wherein the blade assembly 20 is rotatable by at least one air flow directed into the blade assembly 20, so that rotation of the blade assembly 20 is adapted to drive the power generating unit 40 to thereby generate an electrical energy.

In the embodiment as shown in FIGS. 2 and 3, the blade assembly 20 includes eight blades 22 aligned in a circular arrangement to surround the hollow space 24 at the centre. The hollow space 24 is a void space through which air stream or wind from one side of the blade assembly 20 can flow across to another side of the blade assembly 20. The blades 22 can be of any shape and/or dimension which are generally determined by the overall size of the device 10 and also the aerodynamic performance required for power generation. In one embodiment, the blade 22 can be substantially planar. In another embodiment, the blade 22 is preferred to include two opposing sides with at least one of the sides bent slightly to form a profiled surface. For example, the two opposing sides can be arranged to bend towards the same direction to form a slightly curved C-shape; or the two sides can be bent in opposite directions to form a wavy S-shape. Preferably, the blades 22 are arranged to align such that the blade assembly 20 is of a swirl-like configuration, which is considered to be more effective to generate the required torque for rotation and thus, higher power generating efficiency. Such a configuration is best shown in FIGS. 4 and 5 which show the blades 22 in transverse cross-section. The transverse cross-section of each blade 22 forms a slightly curved C-shape, with one end of the transverse cross-section directed towards the hollow space 24 and the transverse cross-section extending radially away from hollow space 24 whilst following the slightly curved C-shape. Nevertheless, a person skilled in the art would appreciate that other numbers, shapes, configurations and/or arrangements of the blades or the blade assembly, should also be encompassed by the present invention, as long as the numbers, shapes, configurations and/or arrangements are considered feasible and suitable for the claimed technical solution.

The frame structure 30 as shown in the figures is of a cubic shape, which is advantageous in that it allows more than one devices 10 be easily combined and/or connected with other another. For example, the cubic structure allows a number of devices 10 be easily stack on top and/or below one another, or be aligned closely in a side by side manner. Although only the embodiments having frame structure of cubic shape is illustrated in the figures, a person skilled in the art would apparently understand that shape of the frame structure may vary according to the specific requirements or applications of the device, without affecting the functions of the frame structure. Accordingly, other three-dimensional shapes or configurations such as polygonal prisms, regular prisms, irregular prisms or even cylindrical arrangements should also be encompassed without departing from the spirit of the present invention.

As shown in FIGS. 2 and 3, the frame structure 30 may comprise a pair of parallelly arranged top and bottom wall portions 32, 34, and one or more supporting members 36 arranged between the top and the bottom wall portions 32, 34 for supporting the wall portions 32, 34. The frame structure 30 may further comprise at least one porous side wall portion 38 arranged between the top and the bottom wall portions 32, 34. The porosity of the side wall portion 38 allows wind from any directions to flow in and out the device 10, and at the same time, functions as a filter to avoid any unintended objects from entering the device 10 which may otherwise interfere with the rotation of the blade assembly 20. The side wall portion 38 may also avoid the rotating blade assembly 20 from being accessible by any person or wildlife which may otherwise cause injury. Preferably, the porous side wall portions 38 are releasably mounted or attached to the frame structure 30 so that one or more of these side wall portions 38 can be removed from the frame structure 30. For example, adjacent side walls of the frame structures of two horizontally connected devices can be removed to allow the two devices to be interconnected.

Preferably, the blade assembly 20 is adapted to movably connect with the power generating unit 40. More preferably, at least one of the plurality of blades 22 is adapted to be movable about an axis c substantially parallel to an axis of rotation b of the blade assembly 20, with the axes best shown in FIG. 3. Accordingly, in addition to the rotational movement of the blade assembly 20 about axis b as driven by the incoming wind which actuates the power generating unit 40 to generate electricity, at least one of the blades 22 may also be movable along axis c to adjust the engaging angle of the air flow with the blades. In one embodiment, one or more of the selected blades 22 may also be controlled to independently or simultaneously movable such that the blade assembly 20 can be arranged to increase or decrease the amount of wind received and/or deflected according to the various wind conditions, such as but not limited to, the speed, the direction and/or the strength of the wind. At least one of the blades 22 may also be controlled to movable according to the amount of power generated or a voltage measured at the power generating unit 40. For example, under a strong wind condition and that the power generated by the power generating unit 40 has exceeded a certain predetermined safety threshold, at least one of the blades 22 can be arranged to move such that the blade assembly 20 is configured to receive less wind, thereby to reduce the speed of rotation of the blade assembly 20 and thus to generate less electricity. On the other hand, when the wind is relatively mild and/or the wind direction is variable or unpredictable, at least one of the blades 22 can be arranged to move such that the blade assembly 20 is more open to receive wind from different directions.

Movement of the blades 22 of the blade assembly 20 can be controlled by a control unit 60. The control unit 60 may comprise a wind sensor 62 adapted to detect the wind condition such as, but not limited to, wind speed, wind direction and/or wind strength; a power meter 64 adapted to measure the generated power and/or the voltage; and/or a computer processing unit 66 adapted to control and adjust movement of the at least one blade 22 according to the detected wind and/or power conditions. The control unit 60 may also adapt to communicate with the power generating unit 40 to adjust or control operation of the power generating unit 40 based on the detected wind and/or power conditions.

Preferably, the device 10 may further comprise a guiding assembly 50 having a plurality of guiding baffles 52, preferably at least three, aligned in a circular arrangement to surround the blade assembly 20. Specifically, the guiding assembly 50 is mounted within the frame structure 30 and surrounds the blade assembly 20. The guiding assembly 50 is adapted to direct the multi-directional air flows entering the device 10 towards the centre where the blade assembly 20 is located, thereby improving the power generating efficiency.

In the embodiment as shown in FIG. 3, the guiding assembly 50 includes eight guiding baffles 52 which extend radially outwardly from the blade assembly 20. Similar to the blades 22, the guiding baffles 52 can be of any shape and/or dimension which are generally determined by the overall size of the device 10 and the blade assembly 20 and also the aerodynamic performance required. Preferably, the guiding baffle 52 is configured to be slightly curved as shown in the figures. More preferably, the plurality of guiding baffles 52 are aligned in a swirl-like configuration. Such a configuration is again best shown in FIGS. 4 and 5 which show the baffles 52 in transverse cross-section. The transverse cross-section of each baffle 52 forms a slightly curved C-shape, with one end of the transverse cross-section directed towards the blade assembly 20 and the transverse cross-section extending radially away from blade assembly 20 whilst following the slightly curved C-shape. The swirl-like arrangement allows the directed air flow to form a whirl-like or rotating air current when reaching the blade assembly 20 at the centre, which further assists in driving the rotation of the blade assembly 20. Despite the preferred arrangements as described above, a person skilled in the art would appreciate that any other shapes, configurations and/or arrangements of baffles, as well as other number of baffles, should also be encompassed, as long as they are considered feasible and suitable for the present invention.

Preferably, at least one of the plurality of guiding baffles 52 is adapted to be movable about an axis d substantially parallel to the axis of rotation b of the blade assembly 20, with the axes best shown in FIG. 3. In one embodiment, one or more of the guiding baffles 52 can be controlled to move about the axis d at various angles, either independently or simultaneously, such that the guiding assembly 50 is adapted to receive and direct an increase or decrease amount of wind towards and/or away from the blade assembly 20 according to the specific wind conditions such as, but not limited to, wind speed, wind direction and/or wind strength. One or more guiding baffles 52 may also be movable according to the amount of power generated or a voltage measured at the power generating unit 40. For example, under a strong wind condition and that the power generated by the power generating unit 40 has exceeded a certain predetermined safety threshold, one or more of the guiding baffles 52 can be moved to allow the guiding assembly 50 to receive less wind, thereby reduce the wind flow towards the blade assembly 20. On the other hand, when the wind is relatively mild and/or when the wind direction is variable or unreliable, one or more guiding baffles 52 can be controlled to move such that the guiding assembly 50 is arranged in a more open configuration to receive more wind from different directions. In the situation when the wind is extremely strong, for example, under a typhoon condition, the guiding baffles 52 may also be movable to form a close configuration of the guiding assembly 50 to substantially enclose the blade assembly 20 to prevent damage of the blade assembly 20 and also the guiding baffles 52.

Movement of the guiding baffles 52 can be controlled by the control unit 60 which is capable of detecting the various wind and/or power conditions and to thereby adjust movement of the guiding baffles 52 accordingly. Details of the control unit 60 has been described earlier in this specification.

The rotation of the blade assembly 20 is converted into electric power by the power generating unit 40. Specifically, the power generating unit 40 may comprise any forms of conventional power generators such as common alternators which convert mechanical energy into electrical energy. For example, the power generating unit 40 may include basic components of at least one set of coil member and at least one magnet member, with their functions and thus the generated power controllable by the control unit 60. In one embodiment, the power generating unit 40 can be arranged at least one of the top and bottom wall portions 32, 34 of the frame structure 30. In another embodiment as shown in FIGS. 2 and 3, the power generating unit 40 comprises a pair of oppositely arranged, inwardly facing disc members 42, 44, with one disc member 42 arranged at the top wall portion 32 and the other disc member 44 arranged at the bottom wall portion 34. A plurality of magnet members 46 can be provided at the disc members 42, 44, which can be aligned, for example, radially or circumferentially at the disc members 42, 44. In this specific embodiment, a corresponding sets of coil members (not shown) are arranged adjacent the magnet members 46 between the corresponding disc members 42, 44 and the respective top and bottom wall portions 32, 34. The relative motion between the magnet members 46 and the coil members generates electricity, which will be detected and controlled by the control unit 60.

Preferably, each of the disc members 42, 44 is configured in a frusto-conical shape, with the two smaller, circular cross-sectional faces pointing towards the hollow space 24 and facing each other. The inclined circumferential surface of the bottom disc member 44 assists in preventing any unwanted dusts, dirt or small stones from accumulating at the hollow space 24, while the inclined circumferential surface of the top disc member 42 assists in preventing ice formation at the surface of the disc member 42 in cold weather.

As shown in the figures, the disc members 42, 44 are adapted to connect with the blade assembly 20 via the plurality of blades 22 such that rotation of the blade assembly 20 drives the disc members 42, 44 into movement, which is subsequently converted into electric power by the power generating components of the power generating unit 40. In one embodiment, a gear system can also be provided at the power generating unit 40 to step up the rotation speed for a higher power generating capacity. As described earlier, the generated electric power can be detected by, for example, the power meter 64 and subsequently, analysed by the computer processing unit 66 of the control unit 60. The computer processing unit 66 may then capable of controlling and adjusting operation of, for example, a selected set or sets of coil members or magnet members, movement of the at least one blade 22, and/or movement of the at least one guiding baffle 52, accordingly to adjust the power generation.

Optionally, the device 10 may comprise a power storage unit adapted to store the generated energy so as to maintain a stabilised power output regardless of the wind condition.

In another embodiment, the device 10 may further comprise a communication module adapted to communicate, physically and/or wirelessly, with one or more of the following: a network such as a server or a database; one or more network connected computers; one or more electronic devices; and one or more wind power generating devices according to the present invention. For example, the communication module can be arranged to wirelessly exchange information such as wind condition parameters and/or power generating data between the device 10 and a network database for record purpose. The communication module may also be arranged to receive operating instructions of the device 10 from a network connected computer. Additionally or alternatively, the communication module may also receive operating instructions from an electronic device such as a portable electronic device. The communication module can also be arranged to communicate with the control unit 60 of the device 10 to control operation of the various components of the device 10. The device 10 can further be provided with any sound-proofing means such as sound damping or buffering members at the moving parts of the device 10 for reducing or preventing noise generation during operation.

FIG. 4 further illustrates a top cross-sectional view of the device 10 which shows the various components of the device 10 including the blades 22, the guiding baffles 52, the disc member 44 with the magnet member 46, and their arrangement at the bottom wall portion 34 f the frame structure 30. The figure also shows the connections 26 where the blades 22 are movably connected to the disc members 42, 44, and the connections 56 where the guiding baffles are movably connected with the top and the bottom wall portions 32, 34. The connections 26 and 56 define the axes c and d, respectively, where each of the blade 22 and the guiding baffle 52 is movable about. The figure further shows the hollow space 24 being surrounded by the blade assembly 20 which is further surrounded by the guiding assembly 50.

The corresponding air flow paths after the wind entered the device 10 is embodied in FIG. 5. Assuming the incoming wind is along the direction as shown by arrows B, the air stream will first flow through the porous side wall portion 38 which filters any big unintended objects outside the frame structure 30. After passing through the porous side wall portion 38, the wind will be directed to flow between at least two consecutive guiding baffles 52 and be converged at regions a. The wind may then proceed to flow directly towards the blade assembly 20 located at the centre of the device 10, or, for some air path, the wind can be deflected by one of the guiding baffles 52 before proceeding further in to engage the blades 22 and to drive the blade assembly 20 into rotation.

Specifically, the reducing cross-sectional area from 52a′ to 52a′ of region a between the two consecutive baffles 52 renders the air flow to proceed in an increasing speed towards the blade assembly 20. When the accelerated air flow engages or ‘hits’ on the surface of one or more blades 22, the air flow drives the blade assembly 20 to rotate in, for example, a clockwise manner as shown in the figure. The rotation of the blade assembly 20 will in turn drive the disc member 44 into rotation which actuates power generation.

After hitting onto the blades for the first time which initiates rotation of the blade assembly 20, the air flow will then pass through the hollow space 24 at the centre of the blade assembly 20 and, if not obstructed by any blades down the path, the air flow will enter one or more regions β and eventually, leave the frame structure 30 via another porous side wall 38. Alternatively, the air flow after passing through the hollow space 24 may engage or be deflected to engage one or more blades 22 of the blade assembly 20 down the path for the second time. The second ‘hit’ may further drive the rotation of the blade assembly 20.

After driving of the blade assembly 20, the air flow will enter one or more regions β between the consecutive guiding baffles downstream, and eventually leave the frame structure 30 via one of the porous side wall 38. The rotatory air current generated by the rotation of the blade assembly will also create one or more low pressure zones at the downstream openings of regions β, which further assist in sucking the air current down the path and then exiting the frame structure 30.

Although only the flow path of the wind coming from direction B is demonstrated in the above embodiment, a person skilled in the art would understand that incoming wind from different or multiple directions would also be encompassed based on a similar reasoning as discussed.

In a further aspect of the present invention, it provides a system 100 for generating wind power which is illustrated in FIG. 6. Specifically, the system 100 comprises a plurality of the device 10 arranged in at least one of a horizontal and a vertical arrangement relative to one another. For example, FIG. 6 shows a system 100 having six cubic devices 10 which are arranged to stack on top of and below one another, and also align side by side with one another. The combinations or arrangement of these devices 10 in a system 100 can be versatile, and the way of installations can be customised according to the location and also the desired power requirement. Particularly, to facilitate connections of the devices 10 with one another to form a system, fastening means 102 which may comprise, for example, hooks, clasps or screws as well as corresponding channels or recesses for engaging those hooks, clasps or screws, can also be provided at the frame structure 30 to suit different connection methods and purposes. In the embodiment as shown in FIG. 6, for example, a number of fastening channels are arranged at corners of the frame structure 30 so that seamless connections between multiple devices can be achieved. The fastening means 102 can also be tailored to allow the series of device 10 in the system 100 be securely fastened at any required surface of a building or on the ground. For example, one or more devices 10 can be attached on a side wall of a building or a structure, or can be suspendedly connected at a ceiling surface or any attachment points to allow the devices be securely hanged above the ground.

In yet a further embodiment, the plurality of devices 10 within the system 100 can be arranged to communicate via the communication module of one or more devices 10. For example, under a certain wind condition, the communication module of one or more devices 10 within the system 100 may adapt to communicate information such as the wind condition parameters and/or the power generation data to thereby determine the corresponding operation settings of the devices so as to allow the system to generate a desired or preset value of a total power output.

The power generated by the multiple devices 10 of the system 100 can be output in series and/or in parallel, depending on the specific power requirements for the system.

1. A device for wind power generation, comprising:
a frame structure having a top wall and a bottom wall oppositely disposed from the top wall;
a blade assembly having a first end that connects to the top wall and a second end that connects to the bottom wall, and a plurality of radially extending blades that extend outwardly from a hollow space sandwiched between the top wall and the bottom wall;
a power generating unit that is movably connected with the blade assembly;
a wind sensor that detects wind parameters;
a power meter that measures a power value of the power generating unit and
a computer processing unit that receives the wind parameters from the wind sensor and the power value from the power meter, and controls a wind receiving angle of the blades based on the received wind parameters and power value,
wherein the blade assembly is rotatable by at least one air flow directed into the blade assembly, so that rotation of the blade assembly drives the power generating unit to thereby generate electrical energy.

2. The device according to claim 1, wherein the wind parameters include wind direction, wind speed, and wind strength.

3. The device according to claim 1, wherein at least one of the plurality of blades of the blade assembly is movable about an axis substantially parallel to an axis of rotation of the blade assembly.

4. The device according to claim 1, wherein the plurality of blades of the blade assembly is arranged in a swirl-like configuration.

5. The device according to claim 1, further comprising a guiding assembly having a plurality of guiding baffles arranged to surround the blade assembly, wherein a wind receiving angle of the guiding assembly is controlled by the computer processing unit to guide an air flow direction and amount.

6. The device according to claim 5, wherein at least one of the plurality of guiding baffles is movable about an axis substantially parallel to an axis of rotation of the blade assembly.

7. The device according to claim 1, wherein the computer processing unit communicates with the power generating unit to control the power generating unit based on the wind parameters and the power value.

8. The device according to claim 1, wherein the computer processing unit controls movement of the at least one of the plurality of blades based on one of a speed of the at least one air flow, a direction of the at least one air flow, an amount of the at least one air flow and a measured voltage at the power generating unit.

9. The device according to claim 5, wherein the plurality of guiding baffles extend radially outwardly from the blade assembly and are controlled by the computer processing unit based on one of a speed of the at least one air flow, a direction of the at least one air flow, an amount of the at least one air flow and a measured voltage at the power generating unit.

10. The device according to claim 1 further comprising a plurality of guiding baffles that are arranged in an adjustable orientation such that the airflow proceed in an increasing speed towards the blade assembly.

11. The device according to claim 1, wherein the blades are arranged in an adjustable orientation such that the air flow engages at least two blades down the path.

12. The device according to claim 1, wherein the frame structure further comprising at least one porous side wall portion arranged between the top wall and the bottom wall.

13. The device according to claim 1, wherein the power generating unit is arranged at at least one of the top and the bottom wall.

14. The device according to claim 1, wherein the power generating unit comprises a pair of oppositely arranged inwardly facing disc members with one disc member arranged at the top wall and the other disc member arranged at the bottom wall, the disc members being adapted to connect with the plurality of blades of the blade assembly such that the disc members are movable by the blade assembly.

15. The device according to claim 1, wherein the frame structure is configured in a shape of a cube, a regular prism or a cylinder.

16. A system for generating wind power comprising a plurality of devices arranged in at least one of a horizontal and a vertical arrangement relative to one another such that two or more of the devices can be stacked and electrically connected, the devices including:
a frame structure having a top wall, a bottom wall oppositely disposed from the top wall and a plurality of guiding baffles each having a top end that connects to the top wall and a bottom end that connects to the bottom wall;
a blade assembly having a first end that connects to the top wall and a second end that connects to the bottom wall, and a plurality of blades that extend outwardly from a hollow space sandwiched between the top wall and the bottom wall;
a power generating unit that is connected with the blade assembly and disposed on a surface of the frame structure;
wherein the guiding baffles are arranged radially in a circular arrangement to surround the blade assembly;
wherein the guiding baffles together with the top wall and bottom wall of the frame structure direct airflows toward the blades,
wherein the guiding baffles are part of the frame structure and function to provide support to the top wall and the bottom wall.
wherein the blade assembly is rotatable by at least one air flow directed into the blade assembly, so that rotation of the blade assembly drives the power generating unit to generate electrical energy.

17. The system of claim 16 further comprising a computer processing unit that controls an output value of the power generating unit based on wind parameters and power values generated by the power generating unit.

18. The system of claim 17, wherein the computer processing unit receives the power value of the power generating unit from the power meter, and adjusts a wind receiving angle for at least one of the guiding baffles to receive less wind when the power value exceeds a predetermined number.

19. The system of claim 16, wherein the guiding baffles are controlled by a computer processing unit to guide an air flow direction and are arranged in an adjustable orientation such that the airflow proceed in an increasing speed towards the blade assembly.

20. A device for wind power generation, comprising:
a frame structure having a top wall, a bottom wall oppositely disposed from the top wall and a plurality of guiding baffles each having a top end that connects to the top wall and a bottom end that connects to the bottom wall;
a blade assembly having a first end that connects to the top wall and a second end that connects to the bottom wall, and a plurality of blades that extend outwardly from a hollow space sandwiched between the top wall and the bottom wall;
a power generating unit that is connected with the blade assembly;
wherein the guiding baffles are arranged radially in a circular arrangement to surround the blade assembly and direct airflows toward the blades,
wherein the blade assembly is rotatable by at least one air flow directed into the blade assembly, so that rotation of the blade assembly drives the power generating unit to generate electrical energy,
wherein a first wind receiving angle of the blades and a second wind receiving angle of the guide baffles are adjustable by a control unit.
